(19) United States
(12) Patent Application Publication
(10) Pub. No.: US 2004/0241057 A1
(43) Pub. Date: Dec. 2, 2004

(54) High efficiency-ozone generator

(76) Inventors: Mark Goodley, Henderson, NV (US); Benedict B St Onge, San Marco, CA (US); Jerry Smith, Fallbrook, CA (US)

Correspondence Address: KOPPEL, JACOBS, PATRICK & HEYBL, 555 ST. CHARLES DRIVE, SUITE 107, THOUSAND OAKS, CA, 91360, US

(21) Appl. No.: 10/468,619

(22) PCT Filed: Feb. 20, 2002
(86) PCT No.: PCT/US02/04893

Related U.S. Application Data
(63) Continuation of application No. 09/793,795, filed on Feb. 23, 2001, now abandoned.
Application No. 09/793,795 is a continuation-in-part of application No. 09/400,260, filed on Sep. 21, 1999, now abandoned.

(51) Int. Cl. B01J 19/08; B01J 19/12

(52) U.S. Cl. 422/186.07

(57) ABSTRACT

A high efficiency system for generating ozone includes a high frequency, high voltage AC power supply, preferably 20 khz at 100 watts. The ozone generator in the system comprising a pair of conductive plates mounted parallel and opposed to each other and a pair of dielectric films. Preferably fused quartz, adhesively secured to the opposed faces of the plates by a heat-conductive, electrically-conductive adhesive. The dielectric films are spaced from each other to define an air space for flow of an oxygen containing air stream there through. The air space encloses corona discharges created when power is delivered to the conductive plates, the corona discharges converting a portion of the oxygen flowing there through to ozone. Cooling means are also provided to the plates.

This is application is a Continuation-in-part of U.S. patent application Ser. No. 09/793,795 filed Feb. 23, 2001 which is a Continuation-in-Part of U.S. patent application Ser. No. 09/400,260 filed Sep. 21, 1999, now abandoned.

### FIELD OF THE INVENTION

The invention is an ozone generator of the plate pair or stack-type plate design employing interleaved electrodes and dielectrics. In certain embodiments, it provides for turbulent oxygen flow and more controlled exposure of the entering oxygen to corona discharge.

More particularly, the ozone generator uses a high wattage power source operating with a high frequency AC current, resulting in a lower reactance and the need for a smaller plate area than prior generators to produce the same or greater amounts of ozone.

### BACKGROUND OF THE INVENTION

Ozone (O₃), an allotropic form of oxygen and a powerful oxidant has increased importance as a disinfectant. Ozone effectively kills bacteria by breaking up their molecular structure, inhibits fungal growth, and inactivates many viruses, cysts, and spores. In addition, soaps, oils, chloramines and many other chemicals can be rendered environmentally safe by ozone treatment. Ozone combines with water to form hydroxyl radicals and peroxide, thus sterilizing the water. Because ozone is unstable, the ozone decomposes to oxygen leaving no residues to further eliminate. Ozone has a half-life of about 22 minutes in water at ambient temperatures. Consequently, for most cleaning/disinfecting operations, the cleaning residue after a short period of time contains only dead biological matter and water and, typically, requires no special disposal.

In typical, conventional corona discharge type ozone generators, a very low percentage of the entering oxygen molecules actually encounter the corona discharge and is converted to ozone. The corona is produced only on one side of a dielectric. As a result, the ozone concentration in the discharged gas is low and the efficiency of the generator is low, particularly with regard to their size. Numerous different designs have been shown in the past for ozone generators. They all typically incorporate two electrodes separated by a dielectric (or insulator operating as a dielectric) with power being supplied to the electrodes through a transformer. Various different combinations of current and voltage are supplied; either AC or DC current have been used.

Cragun, U.S. Pat. No. 2,113,913 is typical of a prior art electrical discharge device which produces a series of small discharges from a 5000 volt source. The unit is attached to a standard 110 volt, 60 cycle AC electrical source which is passed through a transformer to provide 5000 volts at a secondary terminal. A pair of electrically conductive plates 26 are separated by a pair of dielectrics 27 which are, in turn, separated by an electrically conductive grid 28. The grid is attached to one terminal of the transformer such that the alternating potential impressed on the grid creates a discharge through the dielectric sheets, charging the plates at one extremity of the cycle. The plates, attached to ground, then discharge at the other extreme of the alternating current cycle. This produces numerous relatively small discharges converting oxygen located between the grid and plates to ozone.

McBlain, U.S. Pat. No. 1,588,976, uses flexible conductors surrounded by an insulator which acts as a dielectric. The insulators may have ridges formed in their surface so that air can flow between alternating rolled or coiled insulated conductors. Electrical current is supplied through typical primary and secondary coils, suggesting the use of a transformer. However, the power supplied to the electrodes (AC or DC) and the ozone output capacity is not indicated.

U.S. Pat. No. 4,062,748 to Imris shows another version of an ozone generator which uses alternating current with a minimum voltage of at least about 20,000 volts to start the corona discharge.

Rice, U.S. Pat. No. 3,607,709 operates at less then amp and 2000 to 4000 volts. Schaefer, U.S. Pat. No. 3,801,791 operates at 5000 to 15,000 volts 60 cps.

Consequently, most ozone generators are limited to use in stationary industrial applications because of their large size and energy requirements. It is particularly desirable in mobile cleaning and disinfecting apparatus using ozone generators that the ozone generator be of compact size and as efficient as possible.

### SUMMARY OF THE INVENTION

This invention is a small size, high voltage, high efficiency ozone generator. A preferred embodiment comprises a) an enclosure including an entry chamber for receiving feed gas, such as air from a dryer, an oxygen concentrator on oxygen supply such as from a liquid oxygen source, or other enhanced oxygen feed sources b) one or more ozone generating cells comprising interleaved electrodes and dielectrics with passageways between the dielectrics for receiving gas from the entry chamber and converting the oxygen therein to ozone, c) an alternating voltage generator connected to the electrodes so as to create corona discharges between adjacent dielectrics, and d) an exit chamber at the other end of enclosure for receiving the ozone containing gas.

A first typical ozone generating cell includes a first electrode, a second electrode, and first and second dielectrics. The first electrode includes a top face. The first dielectric includes a top and bottom face. The bottom face is opposed to the top face of the first electrode and separated therefrom so as to form a first passageway. The second electrode includes a bottom face opposed to the top face of the first dielectric and separated therefrom so as to form a second passageway. The received gas flows through the passageways. The top face of the first electrode may include a plurality of crests and troughs relative to the bottom face of the dielectric oriented across the flow of received gas through the first passageway. The bottom face of the second electrode may also include a plurality of crests and troughs relative to the top face of the dielectric and mirroring said crests and troughs of the top face of the first electrodes. The passageways between the crests and the dielectric will typically have a uniform gap or spacing.

A second ozone generating cell comprises two opposed electrodes with first and second dielectric layers adhesively attached respectively to the opposed faces of the electrodes. The unattached faces of the first and second dielectric films are spaced apart and provide a flow space for feed oxygen to be exposed to a corona discharge emanating from the dielectric films.

When powered, each dielectric provides a plurality of points of corona discharges on its unattached sides. The received gas must flow through substantially a continuous curtain of corona discharge. The turbulent flow is also created by the device construction, an increased gas flow rate and turbulence resulting from the corona heating of the feed gas in contact with the cooler dielectric films This cell design also eliminates the requirements for a corrosion resistant construction materials, such as stainless steel heat sink surfaces for corrosion resistance against nitric acid by—products created when air is used as a feed gas for ozone generators.

### BRIEF DESCRIPTION OF THE DRAWINGS

FIG. 1 is a diagram of a first embodiment of an ozone generating device including features of the invention.

FIG. 2 is a partial perspective view of an ozone generating cell of the embodiment of FIG. 1.

FIG. 3 is a partial vertical cross-sectional view of the ozone generator of FIG. 1.

FIG. 4 is a partial vertical cross-sectional view of a second embodiment incorporating features of the invention.

FIG. 5 is a partial vertical cross-sectional view of a third embodiment incorporating features of the invention.

FIG. 6 is a top schematic diagram of a typical assembly including a single cell ozone generator incorporating features of the invention.

FIG. 7 is a top cutaway view through the ozone generator portion of FIG. 6 showing the heat dissipation fins and gas inlet and outlet.

FIG. 8 is an enlarged cutaway view of the circled portion of FIG. 7.

FIG. 9 is a graph showing the relationship between Reactance and Frequency for a preferred embodiment.

FIG. 10 is a graph showing the continuous relationship between RMS current and frequency in a preferred embodiment.

FIG. 11 is a graph showing the relationship between voltage at constant current and frequency for a preferred embodiment.

FIG. 12 is a graph showing the relationship between power density/square inch and voltage for a preferred embodiment.

FIG. 13 is a graph showing the percentage of ozone in an exiting gas stream for a preferred embodiment.

FIG. 14 is a cutaway side view showing a variation of the plates within the ozone generator.

FIG. 15 is a bottom view of the upper plate portion of the ozone generator.

### DETAILED DESCRIPTION OF THE INVENTION

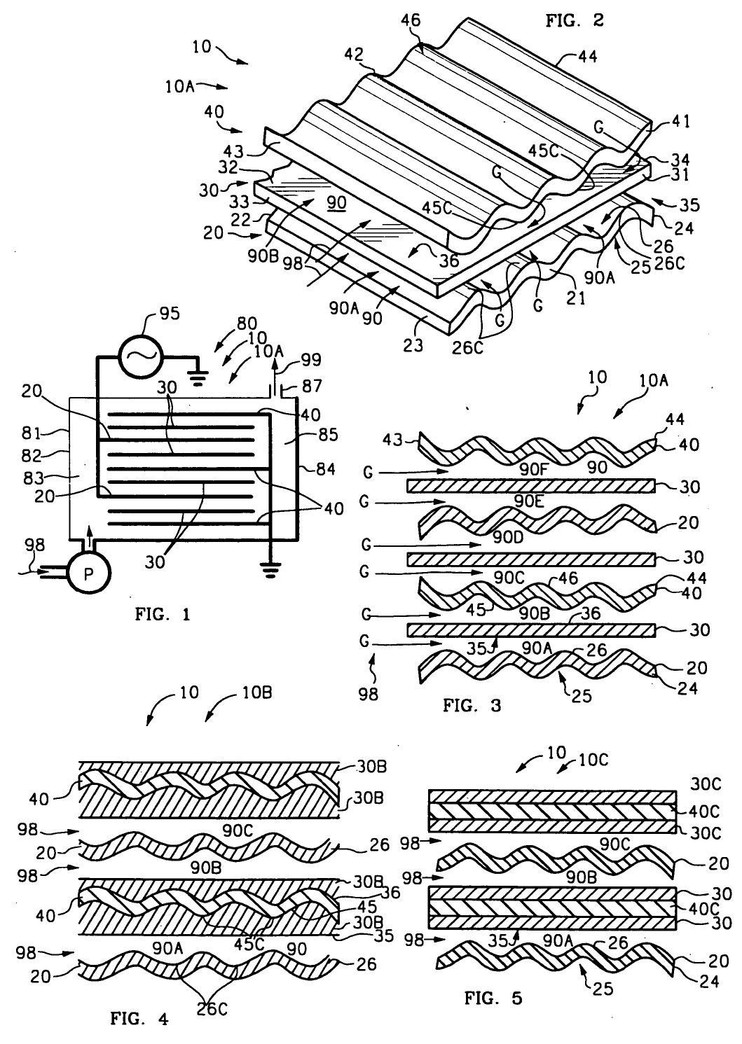

FIG. 1 is a diagram of an ozone generating device 80 including an enclosure 81 containing a first embodiment 10A of the ozone generator 10 of the invention. Gas, including oxygen, such as air 98 from a dryer, an oxygen concentrator, another oxygen source or an oxygen enriched stream is received by propelling means, such as pump P, and propelled into an entry manifold of chamber 83 at one end 82 of enclosure 81. Entering air 98 flows through ozone generator 10A, where the oxygen gas is converted to ozone. The gas including ozone 99 enters exit manifold or chamber 85 at the other end 84 of enclosure 81 and exits through exit orifice 87.

Ozone generator 10A includes a plurality of ozone generating cells including a plurality of high potential electrodes, such as first electrodes 20, connected to an alternating resonant mode high voltage source 95, a plurality of earth or ground electrodes, such as second electrodes 40, connected to ground and a plurality of dielectrics 30, a dielectric 30 being disposed between adjacent first electrodes 20 and second electrodes 40. Electrodes 20, 40 and dielectrics 30 are all mounted interleaved in spaced relationship with their faces opposed. In this manner, first electrodes 20 and second electrodes 40 are electrically connected such that alternating high voltage electrical potentials exist between them.

The walls of enclosure 81 are sometimes used as the two outer-most second electrodes 40. Enclosure 81 is cooled in a manner known in the art.

FIG. 2 shows a partial perspective view of an embodiment of an ozone generating cell of the ozone generator 10A of FIG. 1. FIG. 3 is a partial vertical cross-section view of FIG. 1.

Ozone generator 10A generally includes a first electrode 20; a first dielectric 30 and a second electrodes 40. First electrode 20 includes a first end 21, a second end 22, an entry side 23, an exit side 24, bottom face 25, and a top face 26. Preferably, first electrode 20 is a corrugated plate such that its top and bottom faces 26, 25 include a plurality of crests and troughs traversing between its first and second ends 21, 22. One end or both ends 21, 22 are supported, such as by enclosure 81 and/or by non-conducting spacers.

First dielectric 30 includes a first end 31, a second end 32, first side 33, a bottom face 35, and a top face 36. Bottom face 35 is opposed to top face 26 of first electrode 20 and separated therefrom so as to form a passageway 90, such as first passageway 90A, for flow of air 98. Dielectric 30 may be made of suitable dielectric materials, such as glass or ceramic, with ceramic being preferred. Ceramic is preferred because it well withstands the temperatures produced, yet does not readily break if subjected to shock or if it is rapidly cooled, as happens in some usage environments of generator 10A.

Second electrode 40 is a corrugated plate and includes a first end 41, a second end 42, an entry side 43, an exit side 44, a bottom face 45, and a top face 46. Bottom face 45 is opposed to top face 36 of first dielectric 30 and separated therefrom so as to form a second passageway 90B. Electrodes 20, 40 may be made out of various different suitable conductive materials as are well-known in the art, such as aluminum or stainless steel, with stainless steel being preferred because of its greater resistance to corrosion.

Oxygen bearing gas 98 feed to the cell flows through first passageway 90A from entry side 23 of first electrode 20 to exit side 24 of first electrode. The oxygen bearing gas 98 also flows through second passageway 90B from entry side 43 of second electrode 40 to exit side 44 of second electrode 40.

Top face 26 of the first electrode 20 includes a plurality of crests 26C and toughs traversing the flow of received gas 98 through first passageway 90A. Bottom face 45 of the second electrode 40 includes a plurality of crests 45C and troughs mirroring the crests and troughs of the top face 26 of the first electrode 20. The gap G between each crest 26C, 45C and dielectric 30 is uniform.

FIG. 3 shows a plurality of first electrodes 20, dielectrics 30 and second electrodes 40 mounted in accordance with an embodiment of the invention. Entry oxygen-bearing gas 98 flows through passageways 90A-90F. The crests and troughs of adjacent electrodes 20, 40 mirror those of the adjacent electrodes thus varying the height of passageways 90 relative to dielectrics 30 with the height being a minimum at gap G between each crest and dielectric 30. Typical size of gap G is 1-3 mm. The resultant electric field strength varies from a maximum between mirrored crests to a minimum between mirrored troughs. Alternating voltage source 95 provides voltage to produce a discharge or corona between mirrored crests and interposed dielectric 30. The wave form for producing the corona discharge is essentially an alternating high-frequency sine wave with a typical voltage range between 4000-10,000 volts and a typical frequency range being 10-30 Kilohertz. As a result, along the length of each gap G, each dielectric 30 has a series of discharge coronas almost continuously touching both bottom and top faces 35, 36 so as to form a curtain of corona. The voltage alternates at high frequency such that all entering gas 98 must pass through a fairly continuous curtain of corona at each gap G. In this manner, all of the oxygen molecules are exposed to corona for disassociating atomic oxygen. The wider areas of passageways 90 between the troughs and dielectrics 30 provide for turbulent flow of air 98 and provide dwell time for recombination of the disassociated oxygen atoms into ozone.

The turbulent flow increases the ozone-forming dwell time within the generator. The back pressure resulting from the turbulent flow increases the pressure concentration of gas exposed turbulent flow increases the pressure concentration of gas exposed to the coronas.

FIG. 4 is a partial vertical cross-sectional view of an alternate embodiment ozone generator 10B, similar to generator 10A except between adjacent electrodes 20, 40 there is only one passageway 90 because the interposed dielectric 30B has a face in contact with the face of one of the electrodes 20, 40. Thus, there is only one passageway 90 for each dielectric 30B.

FIG. 5 is a partial vertical cross-sectional view of a further alternate embodiment ozone generator 10C, similar to 10B except the electrodes of one set of electrodes, such as ground electrodes 40C, are flat and have both their faces in contact with the adjacent interposed dielectrics 30C.

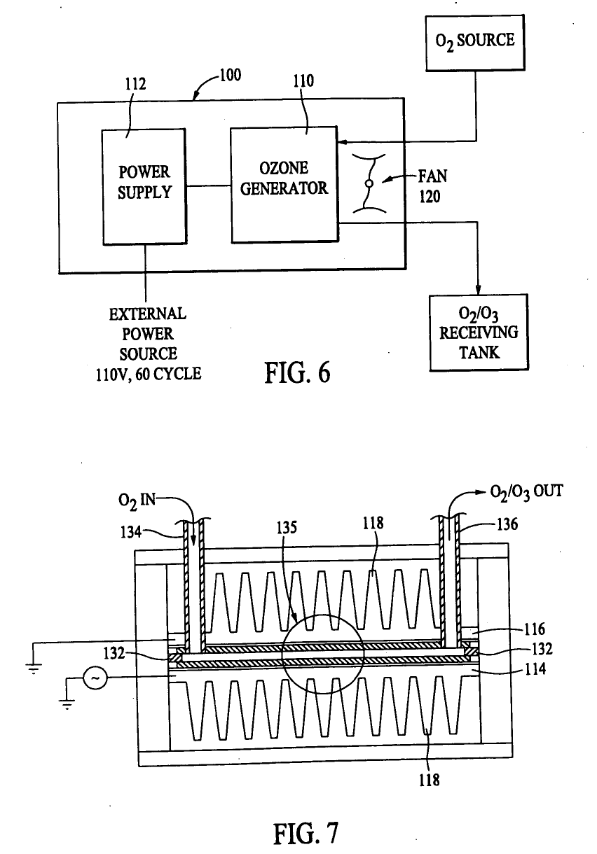

FIG. 6 is a schematic representation of an ozone generating assembly 100 incorporating a single cell ozone generator 110 embodiment incorporating features of the invention. In the embodiment shown 110 volt, 60 cycle AC power is feed to a power supply 112 which incorporates electronics and a transformer for providing the high voltage, high frequency power feed to a first plate 114 of the ozone generator. A suitable power supply is provided as the ET or ETI series electronic transformers by Plasma Technics, Inc. of Racine Wis. These units convert 110/120V or 220V, 50/60 hz input to a substantially sinusoidal 50 or 100 watt, 20 khz output (resonant mode) and are particularly designed for continuous duty corona discharge ozone generators. The circuits used in these power supplies are believed to be described in U.S. Pat. No. 5,313,145. A second plate 116 of the ozone generator 110 is connected to ground. The assembly also includes a cooling fan 120 to blow cooling air over the flutes 118 extending from the outer surface of the plates.

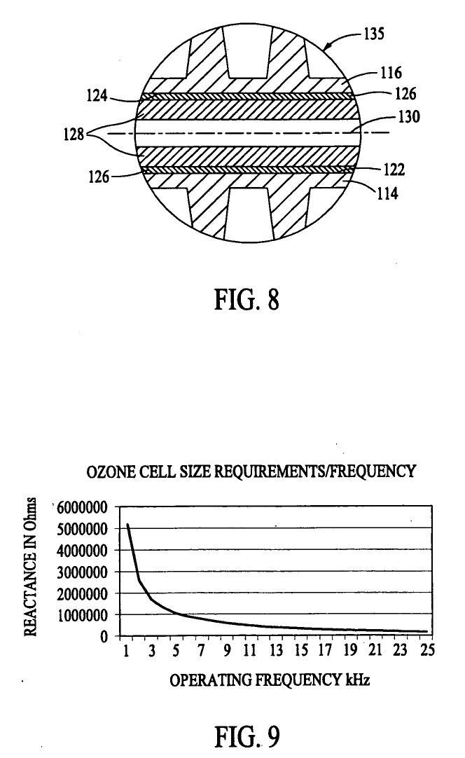

As best shown in FIG. 7, and the enlarged view in FIG. 8 of the circled portion 135 of FIG. 7, both plates 114, 116 have flutes, fins or elongated projections 118 extending therefrom to allow dissipation of heat generated in the ozone generator 110 during operation. The inner face 122 of the first plate 114 faces the inner face 124 of the second plate 116. In the figures, the inner faces 122, 124 have an exposed rectangular surface. However, various different shaped surfaces, including square, circular, oval, as well as numerous other two dimensional geometric shapes may be used. Mounted on each of the inner faces 122, 124, using an electrically and thermally conductive, heat stable adhesive 126, is a dielectric film 128. These two dielectric films which are sized to approximately match the size of the inner faces 122, 124 are separated by an air space 130. The distance between the plates, ie the thickness of the air space, which constitutes an oxygen flow path, is maintained by a gasket 132 which surrounds the air space on all sides (i.e. four sides in the case of a square or rectangular inner face 122, 120). A secondary seal of liquid silicone adhesive (not shown) is applied to the outer sealing edge between 116, 132 and 114, 132. to reduce corona leakage into the air during operation. Air, or an oxygen enriched gas stream, is feed through inlet tube 134 into the air space 130 where it is exposed to a corona created between the dielectric films by application of high frequency, high voltage alternating current to the first plate 112. The corona causes a portion of the oxygen in the feed stream to be converted to ozone. The ozone containing stream then exits the ozone generator through outlet tube 136.

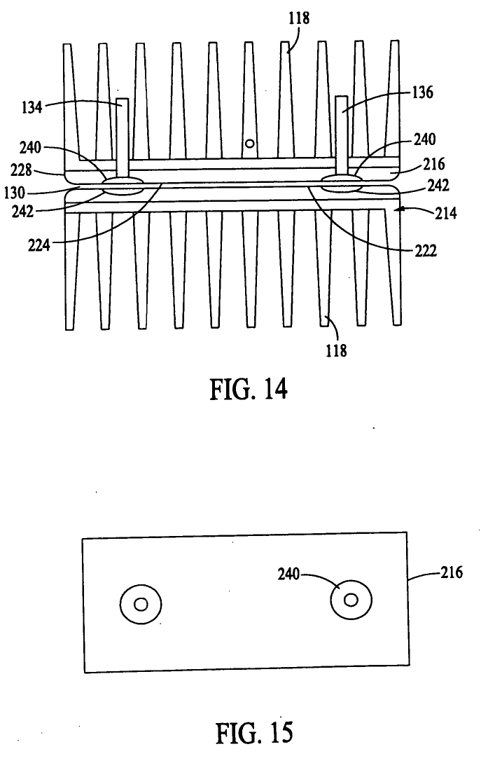

FIGS. 14 and 15 show a variation of the plates 114, 116 shown in FIGS. 6 and 7 used in the ozone generator. FIG. 14 is a side view of the assembled plates 214, 216; FIG. 15 is a view of the bottom of the upper plate 216. The bottom view of the second (bottom) plate 214 is the same as that of the: upper plate 216 with the exception that the bottom plate 214 does not include the air inlet tube 134 and the air outlet tube 136. Both plates 214, 216 have flutes, fins or elongated projections 118 extending there from to allow dissipation of heat generated in the ozone generator 110 during operation. The inner face 224 of the upper plate 216 faces the inner surface 222 of the bottom plate 214. In the figures, the inner faces 222, 224 have an exposed rectangular surface with rounded outer edges 228. The bottom surface 224 of the upper plate 216 differs from that of the first variation shown in FIGS. 7 and 8 in that the upper plate 216 has hemispherical indentations (dimples) 240 at the base of the air flow tubes 134, 136. In a like manner, the bottom plate 214 has matching hemispherical indentations (dimples) 242 which are positioned directly opposite the indentations 240 in the upper plate 216 after assembly, as shown in FIG. 14. The purpose of the dimples 240,242 is to steer the corona away from the inlet and outlet flow tubes 134, 136 on the upper plate 216, which is accomplished by the increased distance between the plates in the region of the dimples. Rounding the outer edges of the plates also has a similar effect in that it directs the corona away from the edges of the plates 214, 216. The result is a slight decrease in the capacitance and the ozone output but the operating life of the assembled unit is believed to be significant increased, possibly 30% or greater Also, threaded stainless tubes used in the embodiment of FIGS. 7 and 8 were replaced by press fit stainless tubes, significantly reducing assembly labor and component costs.

In the embodiment of FIGS. 14-15 the electrically and thermally conductive adhesive 126 and dielectric film 128 were replaced by a more effective, long lasting and economical coating. In particular, a bond coat of zirconium alloy was applied to the inner faces 222, 224 of the aluminum plates 214, 216. A coating of 98.0 to 99.6% aluminum oxide was then flame sprayed onto the bottom surfaces 222, 224 to create an insulating coating from about 0.020 to about 0.040 inches thick, preferably about 0.030 inches thick, on each surface. When the flame spraying of the ceramic coating is applied perpendicular to the lower surface of the plates 214, 216 the flow tubes 134, 136 also become coated, further enhancing operating life of the unit.

For all generators, there is a relationship between the plate size and the frequency of electrical current provision. The lower the frequency, the lower (or the larger the Xc) the reactance through a dielectric is. The higher the frequency, the smaller the reactance is. Further, the power density is a function of watts delivered per square inch of plate inner face 122 surface area. Values for frequency vs. reactance for a preferred fused quartz dielectric are listed in Table I and shown in FIG. 9

TABLE 1

| Frequency | Reactance in |
|---|---|
| in KHz | Ohms |
| 1 | 5134030.5 |
| 2 | 2567015.3 |
| 3 | 1711343.5 |
| 4 | 1283507.6 |
| 5 | 1026806.1 |
| 6 | 855671.75 |
| 7 | 733432.93 |
| 8 | 641753.81 |
| 9 | 570447.83 |
| 10 | 513403.05 |
| 11 | 466730.05 |
| 12 | 427835.88 |
| 13 | 394925.42 |
| 14 | 366716.46 |
| 15 | 342268.7 |
| 16 | 320876.91 |
| 17 | 302001.79 |
| 18 | 285223.92 |
| 19 | 270212.13 |
| 20 | 256701.53 |
| 21 | 244477.64 |
| 22 | 233365.02 |
| 23 | 223218.72 |
| 24 | 213917.94 |
| 25 | 205361.22 |

Low reactance numbers at high frequency combine to give smaller area requirements for the plate(s) in a generator design. For example, using a constant power device (100 watts of power) at a given frequency (20 Khz), 5000 volts and 0.020 Amps can be provided. This also means that a reactive load of 250K ohms (Xc) can be driven.

Without regard to dielectric spacing, required plate area will increase as frequency decreases. The formula for determining plate capacitance is:

C=(0.885×(dielectric constant)×cm²×(number of plates)/dielectric spacing (cm).

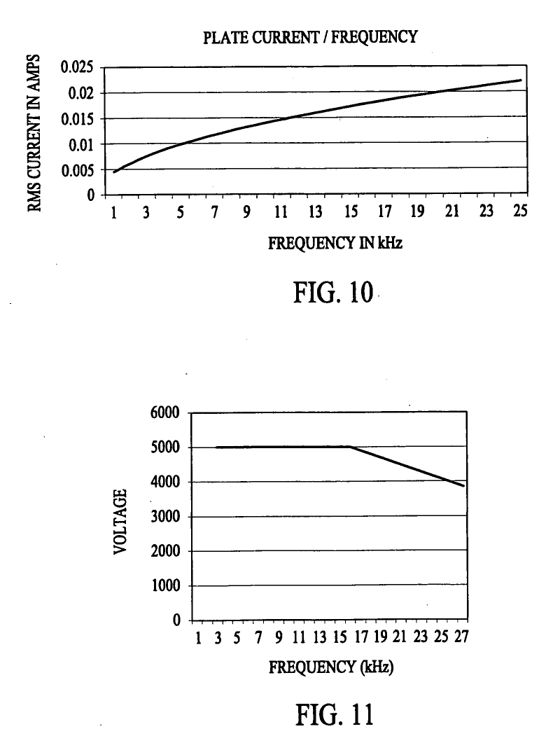

Using fused quartz as the dielectric (dielectric constant=3.78) the values listed in Table II and FIG. 10 are obtained.

TABLE II

| Frequency | Reactance | Power in | plate current |
|---|---|---|---|
| (KHz) | (OHMs) | (Watts) | amp/in² |
| 1 | 5134030.51 | 100 | 0.004413374 |
| 2 | 2567015.255 | 100 | 0.006241454 |
| 3 | 1711343.503 | 100 | 0.007644189 |
| 4 | 1283507.627 | 100 | 0.008826749 |
| 5 | 1026806.102 | 100 | 0.009868605 |
| 6 | 855671.7516 | 100 | 0.010810515 |
| 7 | 733432.93 | 100 | 0.011676691 |
| 8 | 641753.8137 | 100 | 0.012482908 |
| 9 | 570447.8344 | 100 | 0.013240123 |
| 10 | 513403.051 | 100 | 0.013956315 |
| 11 | 466730.0464 | 100 | 0.014637507 |
| 12 | 427835.8758 | 100 | 0.015288378 |
| 13 | 394925.4238 | 100 | 0.015912648 |
| 14 | 366716.465 | 100 | 0.016513335 |
| 15 | 342268.7007 | 100 | 0.017092926 |
| 16 | 320876.9069 | 100 | 0.017653498 |
| 17 | 302001.7947 | 100 | 0.018196809 |
| 18 | 285223.9172 | 100 | 0.018724362 |
| 19 | 270212.1321 | 100 | 0.019237453 |
| 20 | 256701.5255 | 100 | 0.019737211 |
| 21 | 244477.6433 | 100 | 0.020224623 |
| 22 | 233365.0232 | 100 | 0.020700561 |
| 23 | 223218.7178 | 100 | 0.0211658 |
| 24 | 213917.9379 | 100 | 0.021621031 |
| 25 | 205361.2204 | 100 | 0.022066872 |

As an example, C=0.5χ3.14159χ FχXc where F is the frequency in hz and Xₑ is reactance in ohms (or is in mulliohms—see table I where X_{c} for 20 khz=256,70 1,525); for a preferred embodiment C=0.5χ3.1415926χ20000*χ250,000)=3.1831E-11 or 31.8 Pico Farads of reactive load.

The ideal size (area) for the plates is highly dependent on the properties of the dielectric and the spacing, between the plates and/or the dielectric film. Using 5000 volts, the ideal spacing (the air gap) determined to be 1 to 2 mm.

TABLE III

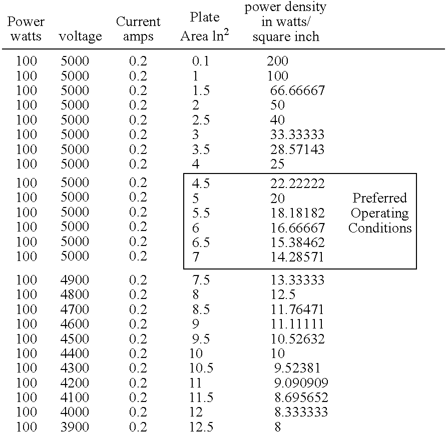

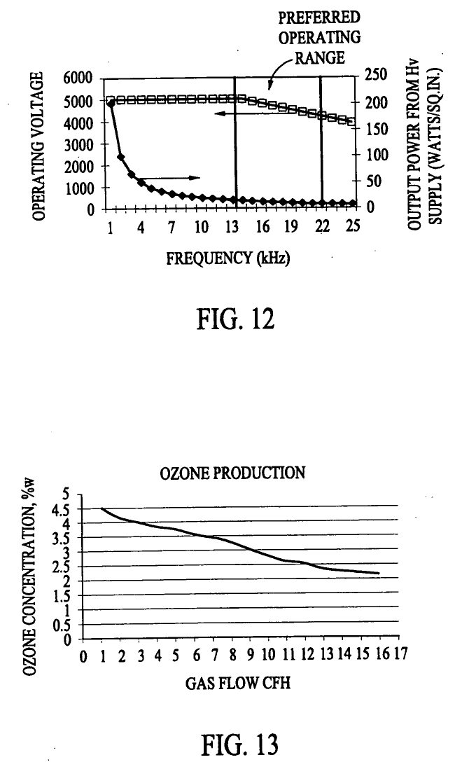

This data shows that the required plate area is reduced to ⅕ by increasing the frequency from 1 to 25 Khz while maintaining the input power fixed. The power remains constant over the area giving reduced voltage or increased current from ideal as stated above (see Table III and FIGS. 11 and 12). The relationship between heat and power are a function of power density (output power) on the plates in watts per square inch (FIG. 12). The production of ozone drops off substantially if the oxygen fed to the generator is heated above 130 deg F. The trade off between power density, plate area, dielectric, spacing and operating temperature is critical to obtain optimum operation. However, it has been determined that an optimal arrangement, using 5 layers of materials between heat sink/conductor plates is.

Layer 1—an electrically and thermally conductive adhesive

Layer 2—a substantially flat 0.02-0.035 layer of fused quartz

Layer 3—a silicone rubber or expanded teflon gasket 0.03125 thick to provide an air gap

Layer 4—a second layer of 0.02-.0.035 layer of fused quartz.

Layer 5—a second layer of electrical and thermally conductive epoxy (see FIGS. 7-8)

The plates can be composed of various conductive materials such as aluminum, stainless steel, or copper. However, a preferred material for this embodiment is 6063 T5 aluminum because of its combination of electrical conductivity and heat conduction. Also various dielectric materials can be used but the preferred material is fused quartz which has at least about 99% silicon dioxide content and a minimal dipole moment internal heating effect. The adhesive must be a electronically and thermally conductive and resistant to heat so that it will hold the dielectric in place, maintaining the air space. The preferred adhesive is a conductive epoxy, such as Master Bond EP76M. A silicone rubber gasket, such as red, 60 durometer silicone gasket provided by, International Belt and Rubber or a Teflon Gasket (Inertech UHF expanded PTFE) preferrably about 1/32″ thick, provides the necessary seal of the air space, resists deformation from heat and is resistant to the ozone levels generated in the device. The secondary liquid seal (not shown) is a GE Silicone II gel sealant.

In a typical preferred embodiment the adhesive is about 0.002 to 0.003 inches thick. The dielectric film, is cut to a rectangular shape about 4 inches by about 1.75 and about 0.015 to about 0.035 in. thick, preferably 0.025-0.035 in. thick. The air space is from about 0.020 to about 0.035 in. thick with the preferred thickness being 0.031 inches. The gasket is also rectangular in shape and sized to both overlap the dielectric film by from about 0.1875 to about 0.3 inches and be wider than the dielectric film by about 0.20-0.250 inches on each side A suitable gasket for the above described dielectric film has outer dimensions of about 4.45 inches by 2.5 inches and a central open space of about 3.4 inches by 1.375 inches, thus providing a 0.145 in³ space between two dielectrics, each having a total exposed surface area of about 4.675 in².

The invention comprises a high frequency design. The objective is to obtain the highest possible energy density without raising the operating temperature above a level where heat will began to destroy the ozone product as fast as it is created. A further alternative is to reduce the surface temperature of the plates by adding more exotic cooling methods such as liquid cooling, PelTier junctions, refrigeration, phase change liquids, etc.

Taking into consideration the economics of ozone generation the limiting factor is the cost of construction, materials, power delivery and space efficiency versus the pounds of ozone generated/time. A preferred construction comprises a unit measuring 6″″×8″×4″ deep,

Uses only room air provided by an internal fan

Produces ozone at 4.8 KWh per pound of ozone

Produces 0.62 pounds of ozone (309 cubic inches per pound of ozone) per day at about a cost of about $400.00 per pound of Ozone

Table IV lists quantities of ozone generated from such a device. These quantities are shown graphically in FIG. 13. The pounds per day of ozone generated (lbs/day ozone) is given by:

$$\frac{\begin{matrix}( {ft}^{3} \text{/} {hr}^{0} {O}_{2} ) \times ( ozone concentration \% ) \times \\ density of {O}_{3} \times {m}^{3} \text{/} {ft}^{3} \times 24\end{matrix}}{454} = 0.50225793$$

This unit optimally produced about 0.50-0.62 pounds/day of ozone, depending on the rate of flow of the feed gas flow.

TABLE IV

| | Ozone | correction | |
|---|---|---|---|
| Oxygen | production | factor for | |
| flow in | (% by | 7 psi | Pounds per |
| SCFH | weight) | pressure | day at 72 F. |
| 1 | 3.5 | 4.4975 | 0.087531245 |
| 2 | 3.2 | 4.112 | 0.160057133 |
| 3 | 3.1 | 3.9835 | 0.232583021 |
| 4 | 2.97 | 3.81645 | 0.297106053 |
| 5 | 2.891 | 3.714935 | 0.36150404 |
| 6 | 2.75 | 3.53375 | 0.412647296 |
| 7 | 2.653 | 3.409105 | 0.464440783 |
| 8 | 2.512 | 3.22792 | 0.502579397 |
| 9 | 2.317 | 2.977345 | 0.521511155 |
| 10 | 2.173 | 2.792305 | 0.543443984 |
| 11 | 2.034 | 2.61369 | 0.559549733 |
| 12 | 1.954 | 2.51089 | 0.58640932 |
| 13 | 1.821 | 2.339985 | 0.592036329 |
| 14 | 1.761 | 2.262885 | 0.616570086 |
| 15 | 1.717 | 2.206345 | 0.644104915 |
| 16 | 1.658 | 2.13053 | 0.663436815 |

From the foregoing description, it is seen that the present invention provides an extremely compact and efficient ozone generator.

Although particular embodiments of the invention have been illustrated and described, various changes may be made in the form, composition, construction, and arrangement of the parts herein without sacrificing any of the advantages. Therefore, it is to be understood that all matter herein is to be interpreted as illustrative and not in any limiting sense, and it is intended to cover in the appended claims such modifications as come within the true spirit and scope of the invention.

1. An ozone generator assembly including:
an alternating voltage, resonant mode generator capable of providing 4000 to 10,000 volts and 50 to 100 watts of power at a frequency of from about 10 khz to about 30 khz,
an ozone generating cell for receiving gas including oxygen and for expelling gas including ozone, and
means for providing gaseous, electrical or evaporative cooling to outer surfaces of the ozone generating cell,
said ozone generating cell including
a first electrode having an inner face, an outer surface and heat dissipating means integral with said outer surface,
a second electrode having an inner face, an outer surface and heat dissipating means integral with said outer surface, the inner face of the second electrode being opposed to, spaced from and parallel to the inner face of the first electrode, the inner faces of the first and second electrodes having substantially the same geometric shape with a width and length defining an electrode surface area,
the outer edges of the first and second electrodes being rounded,
a first dielectric film attached to the inner face of the first electrode by a heat conductive material to enhance attachment,
a second dielectric film attached to the inner face of the second electrode by a heat conductive material to enhance attachment, the first and second dielectric film having a geometric shape the same as the inner face of the electrodes and a width and length not greater than the width and length of the inner face of the electrodes,
an air space located between the first dielectric film and the second dielectric film to form a gas flow passageway, and a corona discharge zone,
a gasket positioned between the first and second dielectric films around an outer periphery of the air space so as to define an enclosed area of the air space of a width and length less than that of the width and length of the dielectric film, and
a gas flow input channel and a gas flow output channel connected to the enclosed area of the air space,
a region of entry of the gas flow input channel to the enclosed area and a region of exit of the gas flow output channel from the enclosed area including a surrounding indentation,
said alternating voltage resonant mode generator being connected to the first electrode and the second electrode for applying voltages thereto to create corona discharges across the air space between the first and second dielectric films.

2. The ozone generator of claim 1 wherein both dielectric films are formed of
a) fused quartz and the material to enhance attachment is a thermally conductive adhesive, or
b) flame sprayed aluminum oxide and the material to enhance attachment is a zirconium alloy.

3. The ozone generator of claim 2 wherein the dielectric film is of a uniform thickness from about 0.015 inches to about 0.035 inches.

4. The ozone generator of claim 1 wherein the material to enhance attachment is a thermally conductive epoxy resin.

5. The ozone generator of claim 1 wherein the gasket is composed of a silicone rubber or expanded PTFE, said gasket overlapping each edge of the dielectric film by from about 0.1875 to about 0.3 inches.

6. The ozone generator of claim 1 wherein the electrode material is aluminum.

7. The ozone generator of claim 1 wherein the heat dissipating means comprises elongated fins extending from the outer surface of each electrode.

8. The ozone generator of claim 7 wherein the means for providing cooling to the ozone generating cell further comprises peltier junctions, refrigerated or phase change liquids or a cooling fan for providing a cooling gas to the heat dissipation means.

9. The ozone generator of claim 1 wherein the alternating voltage generator provides 100 watts of power at a frequency of about 20 khz resonant mode.

10. The ozone generator of claim 9 wherein the space between the first dielectric film and the second dielectric film is from about 0.020 to about 0.0350 inches.

11. The ozone generator of claim 9 wherein the dielectric film is fused quartz or flame sprayed aluminum oxide having a uniform thickness from about 0.015 inches to about 0.035 inches.

12. The ozone generator of claim 9 wherein the dielectric film is fused quartz or flame sprayed aluminum oxide having a uniform thickness of from about 0.025 to about 0.035 inches.

13. The ozone generator of claim 9 wherein the gasket is composed of a flat silicone rubber film having a thickness of about 0.03125 inches, defining an enclosed space having a width and length in each direction of about 0.375 to about 0.6 inches less than the width and length of the dielectric film and the gasket having an outer width and length equal to from about 0.4 to about 0.5 inches greater than the width and length of the dielectric film.

14. The ozone generator of claim 9 wherein the enclosed space defined by the gasket has an area of about 4.675 in² with a thickness from about 0.028 to about 0.035 inches.

15. The ozone generator of claim 1 wherein the surrounding indentation in the region of entry of the gas flow input channel and the region of exit of the gas flow output channel is hemispherical.
